(19) United States
(12) Patent Application Publication
(10) Pub. No.: US 2007/0033173 A1
(43) Pub. Date: Feb. 8, 2007

(54) Method and apparatus for data search with error tolerance

(75) Inventor: Tzu-Ping Jan, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/496,620

(22) Filed: Aug. 1, 2006

(30) Foreign Application Priority Data
Aug. 3, 2005 (TW) 094126371

(51) Int. Cl. G06F 17/30

(52) U.S. Cl. 707/3

(57) ABSTRACT

A data searching method and apparatus with error tolerance for an electronic device storing a plurality of data strings are disclosed. A proposed data searching method includes: extracting a portion of characters of each data string to form a characteristic character set for the data string; receiving an input value sequence; and searching out at least one target data from the plurality of data strings, where the target data includes characters corresponding to the input value sequence, and the characteristic character set of the target data has one character corresponding to a leading character of the input value sequence.

### BACKGROUND OF THE INVENTION

1. Field of the Invention

The present invention relates to data searching techniques, and more particularly, to a method and apparatus of data searching with error tolerance.

2. Description of the Prior Art

Due to the rapid progress of technology, many electronic products and communication devices have become smaller and lighter, enabling users to carry them more easily. Users often store large amounts of data inside cell phones, Personal Digital Assistants (PDA), or similar portable consumer products. Examples of such data include telephone numbers, names, and email addresses of friends, customers and acquaintances. Therefore, how to provide a data searching mechanism allowing the user to efficiently search numerous data for desired data in a convenient way is an important issue in designing these products.

In the prior art, if a user wants to find certain data in a cell phone or PDA, they need to use a selection key to read each data entry one by one. Obviously, this searching method is not ideal, especially when the data amount is significantly large. In another prior art method, the user can input a key string composed of several leading characters of the needed data, and the system will automatically show data complying with the inputted string. For example, if the user inputs a character “a”, the system locates all data starting with the character “a” from the database or memory unit. If the user then inputs a character “s”, the system then locates all data starting with the characters “as”. Similarly, if the user then inputs a character “u”, the data starting with the characters “asu” are shown. Therefore, each times the user inputs more characters, the data complying with the inputted characters become fewer. At a certain point, the user can successfully utilize the selection key to select the required data from the data complying with the inputted characters.

In the above-mentioned data searching method, the user can only find the desired data by inputting the characters of the key string in a correct order. Once the input order of the characters of the key string is not correct, the desired data cannot be found by employing the above data searching method. For example, assume the user needs to find a data string “Randy Chan” stored in the phone book of the cell phone. If the user inputs key string “Rnady” to search the data string “Randy Chan”, because the order of “a” and “n” is not correct, the data string “Randy Chan” is not searched. On the other hand, if the user inputs the family name part “Chan”, because the string “Chan” is not the leading characters of the data string “Randy Chan”, the data string cannot be searched, either. In view of the foregoing, it can be appreciated that the conventional data searching method does not have error tolerances and the data searching efficiency has to be improved.

### SUMMARY OF THE INVENTION

It is therefore one of the primary objectives of the claimed invention to provide a data searching method and related data searching device having error tolerances, to solve the above-mentioned problem and raise the utilization convenience.

According to an exemplary embodiment of the claimed invention, a data searching circuit utilized in an electronic device is disclosed. The data searching circuit comprises: a storage medium, for storing a plurality of data strings; a character extracting unit, for extracting a portion of characters of each data string to form a characteristic character set for the data string; a searching module, electrically connected to the storage medium and the character extracting unit, for searching at least one target data, wherein the target data comprises characters corresponding to an input value sequence, and the characteristic character set of the target data has one character corresponding to a leading character of the input value sequence.

According to another exemplary embodiment of the claimed invention, a data searching method utilized in an electronic device is disclosed. The electronic device stores a plurality of data strings. The data searching method comprises: extracting a portion of characters of each data string; generating a characteristic character set corresponding to the data string; receiving an input value sequence; and searching at least one target data from the plurality of data strings, the target data comprising characters corresponding to the input value sequence, and one character of the characteristic character set of the target data corresponding to a leading character of the input value sequence.

According to another exemplary embodiment of the claimed invention, a machine readable medium containing executable program code is disclosed. When the executable program code executed by an electronic device with a plurality of stored data strings, the electronic device performs the following operations: extracting a portion of characters of each data string; generating a characteristic character set corresponding to the data string; receiving an input value sequence; and searching at least one target data from the plurality of data strings, the target data comprising characters corresponding to the input value sequence, and one character of the characteristic character set of the target data corresponding to a leading character of the input value sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data searching circuit of an embodiment according to the present invention.

FIG. 2 is a flow chart of the data searching method of a first embodiment according to the present invention.

FIG. 3 shows data parameter sets of three different embodiments according to the present invention.

FIG. 4 is a diagram of a data parameter set of another embodiment according to the present invention.

FIG. 5 is a flow chart of the data searching method of a second embodiment according to the present invention.

### DETAILED DESCRIPTION

The present invention data searching method and apparatus can be utilized in many portable communication devices (such as cell phones), PDAs, personal computers, or other digital information products. In general, many data stored in the electronic devices are data strings, which are composed of letters, double-byte characters, numbers, and punctuation marks. As mentioned previously, these stored data may be names, addresses, email addresses, and telephone numbers of friends, customers, or websites. These data strings may include at least one delimiter. Note that, the term “delimiter” as used herein encompasses all characters other than the letters, double-byte characters, and numbers. For example, blank space, punctuation marks, “_”, “-”, “@”, “/”, “\”, and other symbols are delimiters. The data string searching method will be illustrated in the following disclosure.

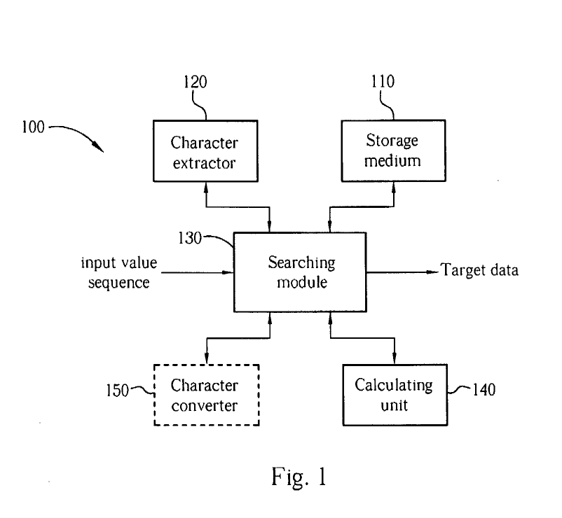

Please refer to FIG. 1, which is a block diagram of a data searching circuit 100 according to an embodiment of the present invention. As shown in FIG. 1, the data searching circuit 100 includes a storage medium 110 for storing a plurality of data strings, a character extractor 120, and a searching module 130 electrically connected to the storage medium 110 and the character extractor 120. The character extractor 120 is utilized for extracting a few characters from a data string to generate a characteristic character set corresponding to the data string. The searching module 130 is utilized for receiving an input value sequence and locating at least one target data from the plurality of data strings, where each target data includes characters corresponding to the input value sequence, and one character of the characteristic character set corresponds to a leading character of the input value sequence. In the actual implementation, the storage medium 110 can be a single storage unit; for example, the storage medium 110 may be an external memory card, or an embedded memory of the electronic device, or other optical or magnetic storage devices. The storage medium 110 can also be a storage module including different types of storage units. In the following disclosure, the operation of the data searching circuit 100 is further illustrated.

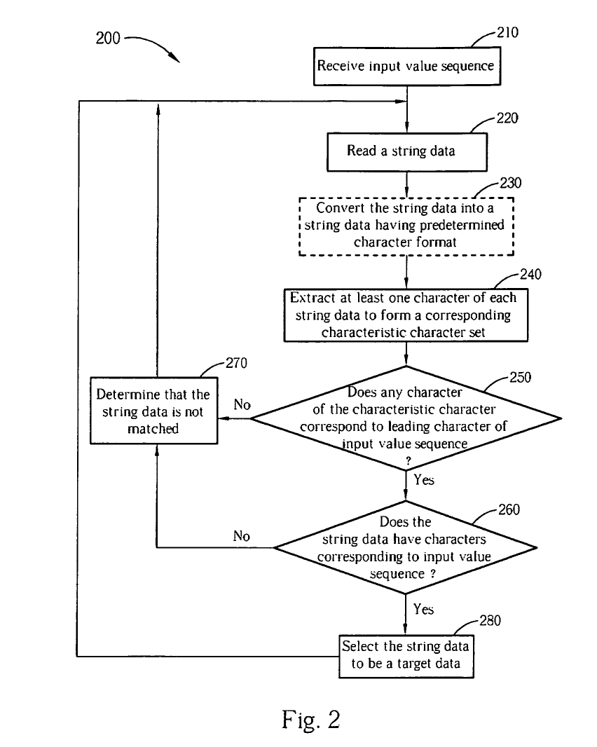

Please refer to FIG. 2, which is a flow chart 200 of the data searching method of a first embodiment according to the present invention. The steps are described in the following paragraphs.

In step 210, the searching module 130 receives an input value sequence from an input module (not shown). The input module may be different according to the type of electronic device applying the data searching circuit 100. For example, if the electronic device is a cell phone, the input module is usually the keypad of the cell phone. On the other hand, if the electronic device is a PDA, the input module may be the touch panel of the PDA. In addition, the input module may also be other interfaces (for example, a keyboard) that allow users to input data, or a voice-controlled module enabling users to input data utilizing their voices. Generally speaking, the data searching circuit 100 includes a buffer (not shown) positioned before the searching module 130 for buffering the input value sequence from the input module. In the actual implementation, if the electronic device is a cell phone, the input value sequence received by the searching module 130 is often a number sequence.

In step 220, the searching module 130 reads one of the data strings from the storage medium 110.

As mentioned previously, the data string read by the searching module 130 in step 220 may include letter-type characters. In a case where an uppercase letter and the same lowercase letter are regarded as being the same character, the data searching circuit 100 can utilize a character converter 150 to perform step 230 to transform the data string into a data string complying with a predetermined format. For instance, the character converter 150 can transform all letter-type characters into either upper case or lower case. In a case where the uppercase letter and lowercase letter should be distinguished from each other, the operation of the character converter 150 has to be removed.

In step 240, the searching module 130 can utilize the character extractor 120 to extract some of the characters of the data string to generate a corresponding characteristic character set. If the data string includes at least one delimiter and the delimiter divides the entire data string into several data segments, the character extractor 120 can extract leading characters of the data segments of the data string to form a characteristic character set. For example, assume the data string is “Randy Chan”, where a space (the delimiter) divides the data string into a first data segment “Randy” and a second data segment “Chan”. In this case, the character extractor 120 can extract the leading character “R” of the first data segment and the leading character “C” of the second data segment to form a corresponding characteristic character set “RC”.

In another case, assume the data string is “Robert S. Andrew”. As it is shown, a space, a period “.”, and another space respectively divide the data string into a first data segment “Robert”, a second data segment “S”, and a third data segment “Andrew”. In this case, the character extractor 120 can extract the leading characters of each data segment of the data string “Robert S. Andrew” to form a corresponding characteristic character set “RSA”. Furthermore, if the data string includes only one data segment, the character extractor 120 can extract the leading character of the data string or the first non-delimiter character of the data string to form the characteristic character set.

In one aspect, the function of the character extractor 120 is similarly to generate an acronym corresponding to the data string. In the practical implementations, the number of characters of the characteristic character set generated by the character extractor 120 can be adjusted according to different system designs. In other words, the present invention does not limit the number of characters of the characteristic character set.

In step 250, the searching module 130 detects whether a character of the characteristic character set, corresponding to the data string, corresponds to the leading character of the input value sequence. As mentioned previously, if the data searching circuit 100 is applied in a cell phone, the input value sequence is often a number sequence. At this time, the searching module 130 can transform the characters of the characteristic character set into the button numbers of the keypad of the cell phone, and then compare the button numbers with the first number of the input value sequence. The characteristic character set “RC” of the data string “Randy Chan” is herein taken as an example. If the character “R” corresponds to the button “7” of the cell phone and the character “C” corresponds to the button “2”, the searching module 130 can transform the characteristic character set “RC” into “72” and detect whether the first number of the input value sequence is 7 or 2 in step 250.

In general, the first input value (the leading character of the input value sequence) inputted by users is often the leading character or the first non-delimiter character of the target data to be searched. Therefore, if the characteristic character set has no character corresponding to the leading character of the data string, the searching module 130 performs the step 270 to determine that the data string does not comply with the searching condition. The data searching circuit 100 then repeats the operations of step 220 step 250 in order to determine whether a next data string stored in the storage medium 110 complies with the above-mentioned searching condition. On the other hand, if the searching module 130 detects one of the characters of the characteristic character set of the data string corresponds to the leading character of the input value sequence in step 250, the searching module 130 performs step 260.

In step 260, the searching module 130 further detects whether the data string includes characters corresponding to the input value sequence. In this embodiment, as long as the data string includes characters corresponding to the input value sequence, the searching module 130 determines that the data string complies with the searching condition no matter whether the order of characters is the same as that of the input value sequence or not. If the detecting result of step 260 is negative, the searching module 130 proceeds to step 270 to determine that the data string does not comply with the searching condition. For example, the searching module 130 can utilize a calculating unit 140 to calculate the appearance times of each character of the data string. The calculating unit 140 detects which characters being contained within the data string and detects the appearance times of each of such characters, and then returns a data parameter set, which is used for representing the calculation result, to the searching module 130. Therefore, the searching module 130 can determine whether the data string includes characters corresponding to the input value sequence according to the above-mentioned data parameter set.

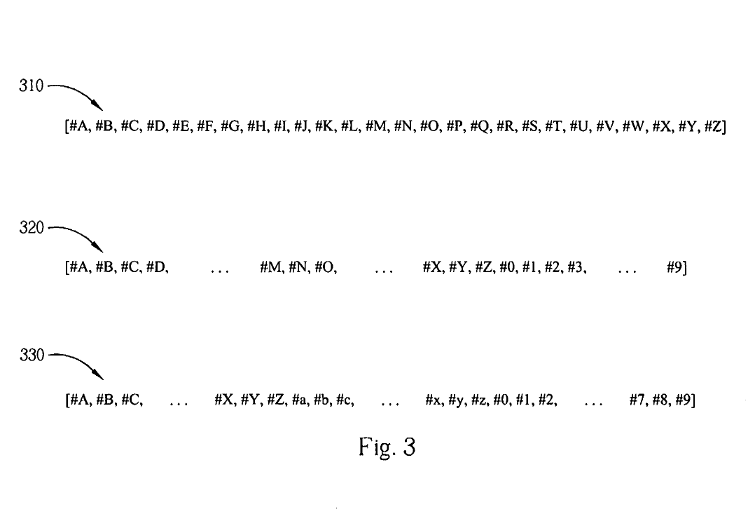

In a preferred embodiment, the calculating unit 140 ignores the delimiters of the data string to raise the efficiency of data searching and improve convenience for the users. In practice, the format and data structure of the data parameter set generated by the calculating unit 140 are not limited. Please refer to FIG. 3, which shows data parameter sets of three different embodiments according to the present invention. In the case where the uppercase and lowercase letters are regarded as being the same, the calculating unit 140 can represent the calculation result of each data string as an array such like a data parameter set 310 shown in FIG. 3. The data parameter set 310 includes 26 entries #A, #B, #C, . . . , #Y, and #Z, where each entry represents the appearance times of the English letters “A”˜“Z” of the data string. For example, assume the data string is “Randy Chan”. In the case where the delimiters are ignored, the calculating unit 140 can set entries #A and #N to 2, set entries #C, #D, #H, #R, and #Y to 1, and set other entries to 0.

Because some of the data strings stored in the storage medium 110 may include number characters, the calculating unit 140 can record the calculating result of characters of a data string in another form such as a data parameter set 320 shown in FIG. 3.

The other data parameter set 330 shown in FIG. 3 is utilized in the application where the uppercase and lowercase letters are different. Take the above data string “Randy Chan” as an example once more. In this embodiment, the calculating unit 140 can set the entries #a and #n to 2, set the entries #C, #R, #d, #h, and #y to 1, and set the other entries to 0.

As long as the value of entries corresponding to the input value sequence is subtracted by 1, it can be determined whether the data string includes corresponding characters of the input value sequence. Taking the above-mentioned “Randy Chan” as an example, in the case where the uppercase and lowercase letters are regarded as being the same, the corresponding data parameter set 310 is [2(#A), 0, 1(#C), 1(#D), 0, 0, 0, 1(#H), 0, 0, 0, 0, 0, 2(#N), 0, 0, 0, 1(#R), 0, 0, 0, 0, 0, 0, 1(#Y), 0]. If the input value sequence is “rain”, the entries of the data parameter set 310, which correspond to characters of the input value sequence “rain”, is subtracted by 1. The subtracted result array is [1 (#A), 0, 1(#C), 1 (#D), 0, 0, 0, 1(#H), −1(#I), 0, 0, 0, 0, 1(#N), 0, 0, 0, 0(#R), 0, 0, 0, 0, 0, 0, 1(#Y), 0].

Because the entry #1 of the result array is less than 0, this represents that the data string “Randy Chan” does not include the character “i” of the input value sequence “rain”, or the number of the character “i” of the data string is less than the number of the character “i” of the input value sequence. Therefore, the searching module 130 determines that the data string “Randy Chan” does not comply with the searching condition. The data searching circuit 100 then repeats the above-mentioned steps to determine whether a next data stream complies with the searching condition.

On the other hand, if the input value sequence is “mday”, the subtracted result array becomes [1(#A), 0, 1(#C), 0(#D), 0, 0, 0, 1(#H), 0, 0, 0, 0, 0, 1(#N), 0, 0, 0, 0(#R), 0, 0, 0, 0, 0, 0, 0(#Y). Because each entry of the result array is not less than 0, this represents that the data string “Randy Chan” includes all the characters of the input value sequence “mday”. Therefore, the searching module 130 determines that the data string “Randy Chan” complies with the searching condition. The searching module 130 then performs step 280 to select the data string “Randy Chan” as a target data. The data searching circuit 100 continuously performs the loop shown in the flow chart 200 until all data strings stored in the storage medium 110 are examined completely.

From the above, it can be appreciated that even the user inputs the characters of the key string in an incorrect order, the data searching circuit 100 can still find out correct target data. In other words, the present invention data searching method and data searching circuit have error tolerance ability.

When the data searching circuit 100 is utilized in a cell phone, the calculating unit 140, in the step 260, can generate a data parameter set corresponding to the data string according to a mapping relationship between the characters of the data string and the input module (such as the keypad) of the cell phone. Assume the mapping relationship between button numbers of the keypad of the cell phone and the English letters is as follows:

“a”, “b”, “c” correspond to the button “2”;

“d”, “e”, “f” correspond to the button “3”;

“g”, “h”, “i” correspond to the button “4”;

“j”, “k”, “l” correspond to the button “5”;

“m, n”, “o” correspond to the button “6”;

“p”, “q” “r”, “s” correspond to the button “7”;

“t”, “u”, “v” correspond to the button “8”; and

“w, x”, “y”, “z” correspond to the button “9”.

In the case where the delimiters are ignored, the characters of the above-mentioned data string “Randy Chan” respectively correspond to the buttons “7”, “2”, “6”, “3”, “9”, “2”, “4”, “2”, and “6” of the cell phone. Therefore, the calculating unit 140 can generate a data parameter set corresponding to the data string “Randy Chan” according to the appearance times of each button number. The data parameter can be represented with the above-mentioned array. For example, the array [0, 0, 3, 1, 1, 0, 2, 1, 0, 1] can be used to represent the appearance times of each of the buttons “0”, “1”, . . . , “9” of the cell phone.

Furthermore, for a data string including double-byte characters (such as Chinese characters or Japanese characters), the calculating unit 140 can generate a data parameter corresponding to the data string according to the input rule of a predetermined input method employed by the electronic device. For example, if a data string is composed of five Chinese characters and the first phonetic notation symbol of each of the five Chinese characters respectively corresponds to the buttons “4”, “1”, “3”, “4”, and “8”, the calculating unit 140 can output a data parameter set [0, 1, 0, 1, 2, 0, 0, 0, 1, 0] to represent the appearance times of buttons “0”, “1”, . . . , “9” corresponding to the characters of the data string.

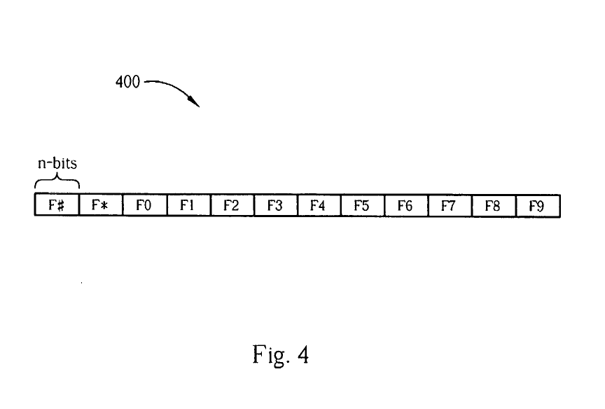

In practical implementations, the data parameter set generated by the calculating unit 140 can be represented by flag bits. Please refer to FIG. 4, which is a diagram of a data parameter set 400 of another embodiment according to the present invention. As shown in FIG. 4, the data parameter set 400 includes 12 fields F#, F*, F0, F1, . . . , F9, which respectively represent the appearance times of the buttons “#”, “*”, “0”, “1”, . . . , “9” corresponding to one data string. In this embodiment, each field of the data parameter set 400 includes n flag bits. For simple illustration, n is herein assumed to be 3. Suppose that a certain data string includes three characters corresponding to the button “3”. The calculating unit 140 can set all three flag bits of the field “F3” of the data parameter set 400 to a first logic level (such as logic 1). If the number of characters corresponding to the button “3” is two, the calculating unit 140 can set two flag bits of the field “F3” to the first logic level, and set the other flag bit of the field “F3” to a second logic level (such as logic 0). On the other hand, if the data string includes no character corresponding to the button “3”, all three flag bits of the field “F3” are set to the second logic level.

Therefore, the searching module 130 can utilize the calculating unit 140 to transform the input value sequence into the same format as the data parameter set 400. Whether a data string includes characters corresponding to the input value sequence or not can be determined through performing AND logic operations on the data parameter set of the data string and the transformed input value sequence. For example, assume that the data parameter set 400 of a data string is a sequence S(string), the transformed result of the input value sequence is a sequence S(input), and the result of the AND operation on the sequence S(string) and the sequence S(input) is a sequence S(result). If the sequence S(result) is the same as the sequence S(input), this represents that the data string includes characters corresponding to the input value sequence. Conversely, if the sequence S(result) is not the same as the sequence S(input), this represents that the data string does not comply with the searching condition.

Taking the data string “Randy Chan” as an example, assume that the input value sequence is “7263” (corresponding to “Rand”), and that each field of the data parameter set includes three flag bits. The data parameter set 400 corresponding to the data string “Randy Chan” is:

000000000000111001001000011001000001 . . . sequence S(string)

The result of the calculating unit 140 transforming the input value sequence into the format of the data parameter set 400 is:

000000000000001001000000001001000000 . . . sequence S(input)

By performing AND operation on the sequence S(string) and the sequence S(input) bit by bit, the searching module 130 can obtain following sequence:

000000000000001001000000001001000000 . . . sequence S(result)

In this case, because the sequence S(result) is the same as the sequence S(input), the searching module 130 determines that the data string “Randy Chan” includes characters corresponding to the input value sequence “7263”. The searching module 130 then performs step 280 to select the data string “Randy Chan” as a target data.

Please note that the sequence S(input), generated through transforming the input value sequence, represents the appearance times of button numbers corresponding to the input value sequence; in other words, the sequence S(input) is not limited by the order of the button numbers. Therefore, even if the user inputs the input value sequence in an incorrect order the calculating unit 140 will still generate the same sequence S(input). The determination result of the searching module 130 is not influenced. In other words, the above-mentioned data searching method has error tolerances, and can still locate correct target data even if the user inputs the input value sequence in an incorrect order.

In the actual implementation, the searching module 130 can temporarily store the searched target data in a buffer or a memory stack, and display the target data on a displaying screen such that the user can utilize a selection button to select needed data.

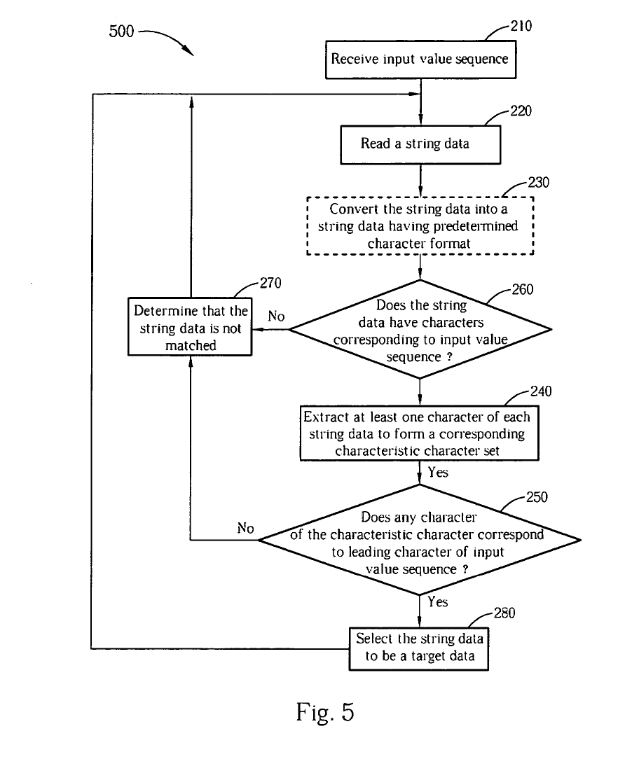

Please note that the order of the above-mentioned flow chart 200 is only utilized as an embodiment, and not a limitation of the present invention. Please refer to FIG. 5, which is a flow chart 500 of the data searching method of a second embodiment according to the present invention. Please note that as the steps having the same number in the flow charts 500 and 200 are substantially the same, a detailed description of each step in FIG. 5 is omitted here. The difference between the flow charts 500 and 200 is the step order. In FIG. 5, the order of the step 250 and step 260 is reversed with respect to the flow chart 200, and step 240 is performed after step 260.

In the actual application, the operations of step 250 and step 260 can be performed simultaneously. For example, in the application of a cell phone, the searching module 130 can utilize the calculating unit 140 to transform the characteristic character set corresponding to the data string into a corresponding sequence H(string) of the data parameter set 400 format, and transform the leading character of the input value sequence into a corresponding sequence H(input) of the data parameter set 400 format. The data string “Randy Chan” having a characteristic character set “RC” will be taken as an example again. Assume that the character “R” corresponds to the button “T” of the cell phone, the character “C” corresponds to the button “2” of the cell phone, and the input value sequence is “7263” (corresponding to Rand). The calculating unit 140 can transform the characteristic character set “RC” into:

000010000100 . . . sequence H(string)

where the 12 bits of the sequence H(string), from left-hand side to right-hand side, respectively correspond to the buttons “#”, “*”, “0”, “1”, . . . , and “9” of the cell phone.

Similarly, the calculating unit 140 can transform the leading character “7” of the input value sequence into:

000000000100 . . . string H(input)

The searching module 130 can connect the data parameter set 400 corresponding to the data string “Randy Chan” (the above-mentioned 36-bit sequence S(string)) and the 12-bit sequence H(string) corresponding to the characteristic character set “RC” to form a 48-bit sequence HS(string). In addition, the searching module 130 further connects the 36-bit sequence S(input) corresponding to the input value sequence “7263” and the 12-bit sequence H(input) corresponding to the leading character “7” to form a 48-bit sequence HS(input). The searching module 130 can then perform an AND logic operation on the sequence HS(string) and the sequence HS(input) to generate a result sequence HS(result). Please note that if the sequence HS(result) is the same as the sequence HS(input) this represents that the data string “Randy Chan” includes characters corresponding to the input value sequence and one character of the characteristic character set “RC” corresponds to the leading character “7” of the input value sequence. On the other hand, if the sequence HS(result) is not the same as the sequence HS(input), the searching module 130 can determine that the data string “Randy Chan” does not match the searching condition.

In other words, through performing the AND operation on the sequence HS(string) and the HS(input) and comparing the sequence HS(result) with the sequence HS(input), the searching module 130 can complete the determination operations of the steps 250 and 260.

Those skilled in the art can write software program codes to implement the above-mentioned data searching method. The software program codes can be stored inside a readable medium (such as a non-volatile memory), and the searching module 130 can be implemented by a processor. When the processor executes a program command stored in the readable medium, the above-mentioned data searching method is performed to select at least one target data from a plurality of data stored in the storage medium 110 according to an input value sequence.

As the disclosed data searching method and data searching circuit have error tolerances, even if the user inputs the searching string in an incorrect order, the system can still find out the correct target data. In contrast to the prior art, this data searching method can raise the efficiency of data search processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data searching circuit utilized in an electronic device, the data searching circuit comprising:
a storage medium storing a plurality of data strings;
a character extracting unit extracting a portion of characters of each data string to form a characteristic character set for the data string;
a searching module electrically connected to the storage medium and the character extracting unit, the searching module searching at least one target data, wherein the target data comprises characters corresponding to an input value sequence and the characteristic character set of the target data has one character corresponding to a leading character of the input value sequence.

2. The data searching circuit of claim 1, wherein the electronic device is a portable communication device.

3. The data searching circuit of claim 1, further comprising:
a calculating unit, electrically connected to the searching module, for calculating appearance times of each character of each data string to generate a data parameter set corresponding to the data string;
wherein the searching module determines whether a data string comprises a specific character corresponding to the input value sequence according to the data parameter set of the data string.

4. The data searching circuit of claim 3, further comprising:
a character converting unit, electrically connected to the searching module, for converting the input value sequence into a specific input value sequence corresponding to a predetermined format, and for converting at least one data string into a data string corresponding to a predetermined character format;
wherein the predetermined character format is either an uppercase character format or a lowercase character format.

5. The data searching circuit of claim 1, wherein the input value sequence is a number sequence.

6. The data searching circuit of claim 5, further comprising:
a calculating unit, electrically connected to the searching module, for generating a data parameter set corresponding to a data string according to a mapping relationship between characters of the data string and an input device of the electronic device;
wherein the searching module determines whether a data string comprises a specific character corresponding to the input value sequence according to the data parameter set of the data string.

7. The data searching circuit of claim 5, further comprising:
a calculating unit, electrically connected to the searching module, for generating a data parameter set corresponding to a data string according to an input rule of the data string under a predetermined input method employed by the electronic device;
wherein the searching module determines whether a data string comprises characters corresponding to the input value sequence according to the data parameter set corresponding to the data string.

8. A data searching method utilized in an electronic device, the electronic device storing a plurality of data strings, the data searching method comprising:
extracting a portion of characters of each data string;
generating a characteristic character set corresponding to the data string;
receiving an input value sequence; and
searching at least one target data from the plurality of data strings, the target data comprising characters corresponding to the input value sequence, and one character of the characteristic character set of the target data corresponding to a leading character of the input value sequence.

9. The data searching method of claim 8, wherein the characteristic character set of each data string comprises a leading character of the data string or a first non-delimiter character of the data string.

10. The data searching method of claim 8, wherein the step of generating the characteristic character set corresponding to the data string further comprises:
if the data string comprises at least one delimiter and the delimiter divides the data string into a plurality of data segments, extracting at least the leading character of part of the data segments of the data string to form the characteristic character set of the data string.

11. The data searching method of claim 8, further comprising:
calculating appearance times of each character of each data string to generate a data parameter set of the data string; and
calculating appearance times of each character of the input value sequence to generate a corresponding searching parameter set;
wherein the step of searching target data further comprises:
determining whether one data string comprises characters corresponding to the input value sequence according to the data parameter set corresponding to the data string.

12. The data searching method of claim 11, further comprising:
transforming the input value sequence into a specific input value sequence corresponding to a predetermined format; and
transforming at least one data string into a specific data string corresponding to a predetermined character format,
wherein the predetermined character format is either an uppercase character format or a lowercase character format.

13. The data searching method of claim 8, wherein the input value sequence is a number sequence.

14. The data searching method of claim 13, further comprising:
generating a data parameter set corresponding to a data string according to a mapping relationship between characters of the data string and an input device of the electronic device;
wherein the step of searching the target data further comprises:
determining whether a data string comprises a specific character corresponding to the input value sequence according to the data parameter set of the data string.

15. The data searching method of claim 13, further comprising:
generating a data parameter set corresponding to a data string according to an input rule of the data string under a predetermined input method employed by the electronic device;
wherein the step of searching the target data further comprises:
determining whether a data string comprises characters corresponding to the input value sequence according to the data parameter set corresponding to the data string.

16. A machine readable medium containing executable program code, which when executed by an electronic device with a plurality of stored data strings cause the electronic device to perform operations comprising:
extracting a portion of characters of each data string;
generating a characteristic character set corresponding to the data string;
receiving an input value sequence; and
searching at least one target data from the plurality of data strings, the target data comprising characters corresponding to the input value sequence, and one character of the characteristic character set of the target data corresponding to a leading character of the input value sequence.

17. The machine readable medium of claim 16, wherein the electronic device is a portable communication device.
